(19) United States
(12) Patent Application Publication
(10) Pub. No.: US 2014/0155067 A1
(43) Pub. Date: Jun. 5, 2014

(54) WIRELESS TERMINAL APPARATUS, SWITCHING METHOD AND MACHINE READABLE MEDIUM

(71) Applicant: FUJITSU LIMITED, Kawasaki-shi (JP)

(72) Inventor: Naritoshi SAITO, Hino (JP)

(73) Assignee: FUJITSU LIMITED, Kawasaki-shi (JP)

(21) Appl. No.: 14/087,978

(22) Filed: Nov. 22, 2013

(30) Foreign Application Priority Data
Dec. 5, 2012 (JP) 2012-266750

(51) Int. Cl. H04W 36/14; H04W 88/06

(52) U.S. Cl. CPC H04W 36/14; H04W 88/06
USPC 455/437; 455/552.1

(57) ABSTRACT

A wireless terminal apparatus includes a first communicator, a second communicator, a memory, and a processor coupled to the memory and configured to, measure a reception level, while a communication to the second communication network is established in a state where a power supply of the first communicator is set as off and also a power supply of the second communicator is set as on, switch the power supply of the first communicator from off to on when the reception level is lower than a first threshold, and switch the communication destination from the second communication network to the first communication network and switch the power supply of the second communicator from on to off when the reception level is lower than a second threshold that is lower than the first threshold.

### CROSS-REFERENCE TO RELATED APPLICATION

This application is based upon and claims the benefit of priority of the prior Japanese Patent Application No. 2012-266750, filed on Dec. 5, 2012, the entire contents of which are incorporated herein by reference.

### FIELD

The embodiment discussed herein is related to a wireless terminal apparatus that can be communicated to plural communication networks, a switching method, and a machine readable medium.

### BACKGROUND

Up to now, communication systems are proposed including a wireless communication system using a code division multiple access (CDMA) communication with use of a spread spectrum method, a communication system using a time division multiple access (TDMA) method, a communication system using an analog wireless signal, and the like.

In addition, up to now, a wireless terminal apparatus that can be communicated to plural communication networks is proposed. For example, a multimode terminal that can be communicated to respective wireless systems including a CDMA2000 1× system, an EVDO system, and a Long Term Evolution (LTE) system is proposed. Hereinafter, CDMA2000 1× will be simply referred to as “1×”.

In association with the above-mentioned technology, in a communication system that can be communicated to two or more different wireless communication networks, a communication system is proposed in which pieces of communication quality information of base stations in the surroundings of both terminals that perform a communication by using one wireless communication network are obtained, and it is determined whether or not the wireless terminal apparatus is to be communicated to the wireless communication network on the basis of the communication quality information.

A mobile wireless communication apparatus is also proposed in which in a waiting state based on Evolved Universal Terrestrial Radio Access Network (E-UTRAN), when an event of a CS-based service is received via the E-UTRAN, a response to the event can appropriately be transmitted to a CS-based access network.

A mobile wireless communication apparatus is also proposed in which in a case where a reception timing for an EVDO paging signal or a predetermined cycle arrives, if a reception power level of a signal received from a base station EVDO BS is lower than a threshold, an LTE reception signal processing unit is activated, a base station LTE BS is searched for, and a call waiting state based on the LTE system is established.

The following wireless communication apparatus is also proposed. This wireless communication apparatus uses a particular wireless access system for calling a wireless communication apparatus and sets an interface other than the interface corresponding to the particular wireless access system as an off state. The wireless communication apparatus activates plural interfaces in a case where a call request is issued and selects a data transmission and reception wireless access system used for transmitting and receiving data with a call destination among those and establishes a communication to the call destination.

These technologies are disclosed, for example, in International Publication Pamphlet No. WO 2008/087931, Japanese Laid-open Patent Publication No. 2010-063014, Japanese Laid-open Patent Publication No. 2010-087869, and Japanese Laid-open Patent Publication No. 2011-249867.

### SUMMARY

According to an aspect of the invention, a wireless terminal apparatus includes a first communicator configured to be communicated to a first communication network that provides a voice communication, a second communicator configured to be communicated to a second communication network that provides a data communication and to notify the wireless terminal apparatus that can be communicated to the second communication network of a call request from the first communication network in a switchable manner, a memory, and a processor coupled to the memory and configured to, measure a reception level with regard to a signal received from a base station included in the second communication network, while a communication to the second communication network is established in a state where a power supply of the first communicator is set as off and also a power supply of the second communicator is set as on, switch the power supply of the first communicator from off to on when the reception level is lower than a first threshold that is previously determined as a reference for conducting a preparation to switch the communication destination from the second communication network to the first communication network, and switch the communication destination from the second communication network to the first communication network and switch the power supply of the second communicator from on to off when the reception level is lower than a second threshold that is lower than the first threshold and is previously determined as a reference for switching the communication destination from the second communication network to the first communication network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram for describing an example of a wireless system that uses a wireless terminal apparatus according to an embodiment.

FIG. 2 illustrates an example of a relationship between a 1×/EVDO communication area and LTE communication areas;

FIG. 3 illustrates a configuration example of the wireless terminal apparatus;

FIG. 4 is an explanatory diagram for describing LTE communication information;

FIG. 5 is an explanatory diagram for describing an outline of device switching processing by the wireless terminal apparatus;

FIG. 6 illustrates an example of a change in an LTE reception CINR in a case where the wireless terminal apparatus is moved from a location a to a location d which are illustrated in FIG. 2;

FIG. 7 illustrates an example of an LTE downlink frame;

FIG. 8 is a flow chart illustrating a specific example of the device switching processing by the wireless terminal apparatus; and

FIG. 9 is a flow chart illustrating a specific example of the device switching processing by the wireless terminal apparatus.

### DESCRIPTION OF EMBODIMENT

Since a population cover rate is low across a service area for a wireless communication based on an LTE system that has recently started to be spread, a problem occurs that along a movement of a wireless terminal apparatus, a location of the wireless terminal apparatus is out of the service area for the wireless communication based on the LTE system, and a communication is cut off.

The wireless communication service based on the LTE system includes a 1×CS Fallback function. When this function is utilized, for example, the wireless terminal apparatus in communication with an LTE base station is notified of a paging from a 1× base station by a paging from the LTE base station. In this case, the wireless terminal apparatus switches a wireless communication from the LTE base station to the 1× base station to carry out a 1× voice communication. When the 1×CS Fallback function is utilized in the above-mentioned manner, it is possible to wait for the paging from the 1× base station during the communication with the LTE base station. In this case, a multimode terminal including interfaces for wireless communications with the respective wireless systems including the 1× system, the EVDO system, and the LTE system can turn off power supplies of the interfaces for the wireless communications with the wireless systems other than the LTE system. In this case, the power consumption of the wireless terminal apparatus can be suppressed to a low level.

However, the population cover rates for the service areas of the wireless communications based on the CDMA2000 1× system and the EVDO system are approximately 98%, but in contrast, the cover rate of the service area for the wireless communication based on the LTE system that has recently started to be spread is approximately 60%. For that reason, if the wireless terminal apparatus moves out of the wireless communication service area based on the LTE system, a problem occurs that the wireless terminal apparatus does not utilize the 1×CS Fallback function, and the paging from the 1× base station is not waited for.

In view of the above, it is conceivable that the power supply of the interface for the wireless communication with the wireless system based on the 1× system is regularly turned on. However, in this case, since both the power supplies of the interface for the wireless communication with the wireless system based on the 1× system and the interface for the wireless communication with the wireless system based on the LTE system are in an on state in the service area for the wireless communication based on the LTE system, a problem occurs that the power consumption is increased.

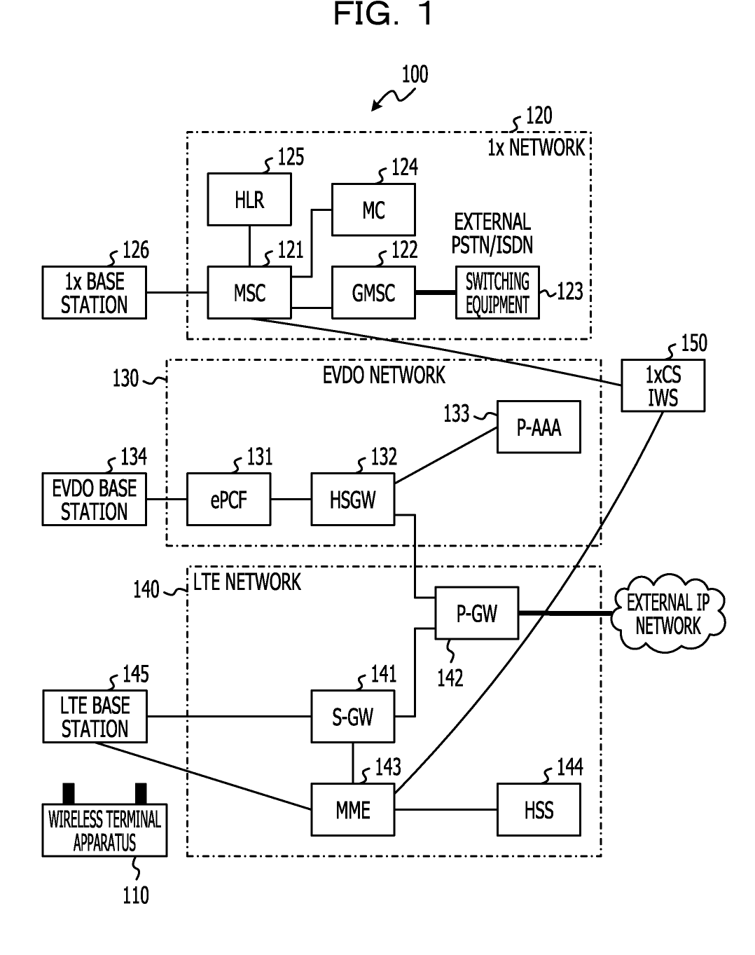

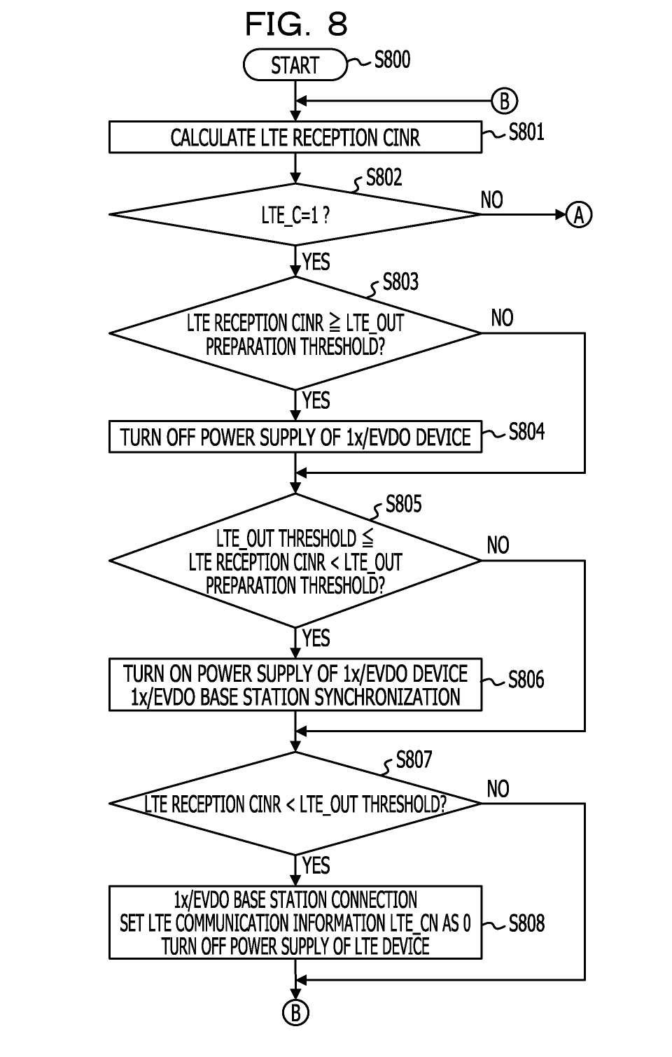

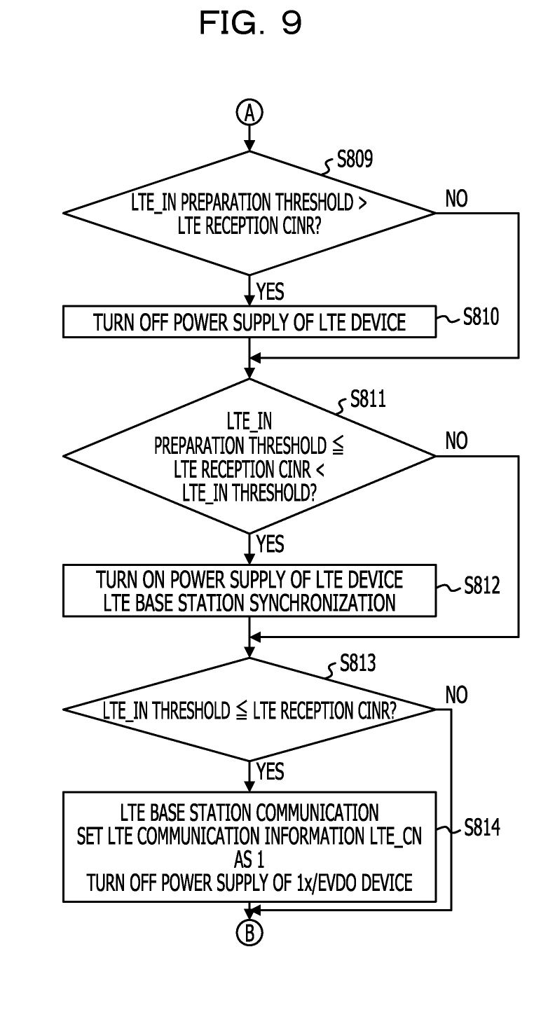

Hereinafter, an exemplary embodiment of the present disclosure will be described on the basis of FIGS. 1 to 9. The embodiment which will be described below is merely an example and is not intended to exclude various modifications and technology applications which will not be specified below. That is, the present embodiment can be implemented through various modifications such as combinations of various technologies described according to the embodiment in a range without departing from the gist thereof. A processing procedure illustrated in a format of flow charts in FIG. 8 and FIG. 9 is not intended to limit a processing order. Therefore, the processing order may of course be changed where applicable.

### Embodiment

FIG. 1 is an explanatory diagram for describing an example of a wireless system 100 that uses a wireless terminal apparatus 110 according to an embodiment.

The wireless terminal apparatus 110 according to the present embodiment is a wireless terminal apparatus that can wirelessly communicate to any of a 1× network 120 corresponding to a wireless system based on the 1× system, an EVDO network 130 corresponding to a wireless system based on the EVDO system, and the LTE network 140 corresponding to a wireless communication based on the LTE system.

In the description on the present embodiment, for example, a case in which “the wireless terminal apparatus 110 is wirelessly communicated to the 1× network 120 or a 1× base station 126” includes a case in which the wireless terminal apparatus 110 waits for a call from the 1× network 120 or the 1× base station 126. The same applies in a case where the wireless terminal apparatus 110 is wirelessly communicated to the EVDO network 130 or an EVDO base station 134 and a case where the wireless terminal apparatus 110 is wirelessly communicated to an LTE network 140 or an LTE base station 145.

Therefore, as illustrated in FIG. 1, the wireless system 100 that uses the wireless terminal apparatus 110 includes the 1× network 120, the EVDO network 130, and the LTE network 140. The wireless system 100 also includes the 1× base station 126 corresponding to a base station of the 1× network 120, the EVDO base station 134 corresponding to a base station of the EVDO network 130, and the LTE base station 145 corresponding to a base station of the LTE network 140.

Since the 1× network 120, the EVDO network 130, and the LTE network 140 included in the wireless system 100 used according to the present embodiment are networks compliant with the 3rd Generation Partnership Project (3GPP) standard, a specific description thereof will be omitted, but the respective networks include the following configurations, for example.

The 1× network 120 includes, for example, a mobile switching center (MSC) 121, a gateway MSC (GMSC) 122, a switching equipment 123, a message center (MC) 124, a home location register (HLR) 125, and the like.

The EVDO network 130 includes, for example, an evolved packet control function (ePCF) 131, a high rate packet data (HRPD) serving gateway (HSGW) 132, a proxy-authentication, authorization and accounting (P-AAA) 133, and the like.

The LTE network 140 includes, for example, a serving gateway (S-GW) 141, a packet data network (PDN) gateway (P-GW) 142, a mobility management entity (MME) 143, a home subscriber server (HSS) 144, and the like.

The EVDO network 130 and the LTE network 140 share the P-GW 142. The EVDO network 130 and the LTE network 140 also share the P-AAA 133 of the EVDO network 130 and the HSS 144 of the LTE network 140. This is because even in a case where the communication switching occurs between the EVDO network 130 and the LTE network 140, the packet communication service is seamlessly provided to the wireless terminal apparatus 110. The MSC 121 of the 1× network 120 and the MME 143 of the LTE network 140 are communicated to each other so as to be mutually communicable via a circuit switched fallback interworking solution function for 3GPP2 1×CS (1×CS IWS) 150.

In the above-mentioned configuration, for example, the 1×CS Fallback function is regulated in 3GPP standard TS23.272. An outline of the 1×CS Fallback function will be described below.

For example, a case will be considered in which the wireless terminal apparatus 110 is wirelessly communicated to the LTE base station 145. In this case, the wireless terminal apparatus 110 does not receive the paging from the 1× base station 126, which will be referred to as “1× paging”. That is, a state is established in which the wireless terminal apparatus 110 is not wirelessly communicated to the 1× base station 126.

In this case, the wireless terminal apparatus 110 is notified of the 1× paging by the paging from the LTE base station 145, which will be referred to as “LTE paging”. Specifically, the LTE base station 145 is notified of the 1× paging from the MSC 121 via the 1×CS IWS 150 and the MME 143. Then, the wireless terminal apparatus 110 is notified of the 1× paging notified from the MME 143 by the LTE paging. The wireless terminal apparatus 110 that has received the notification of the 1× paging performs the wireless communication with the 1× base station 126 and establishes a communication line with a terminal apparatus at a call source to start a voice communication.

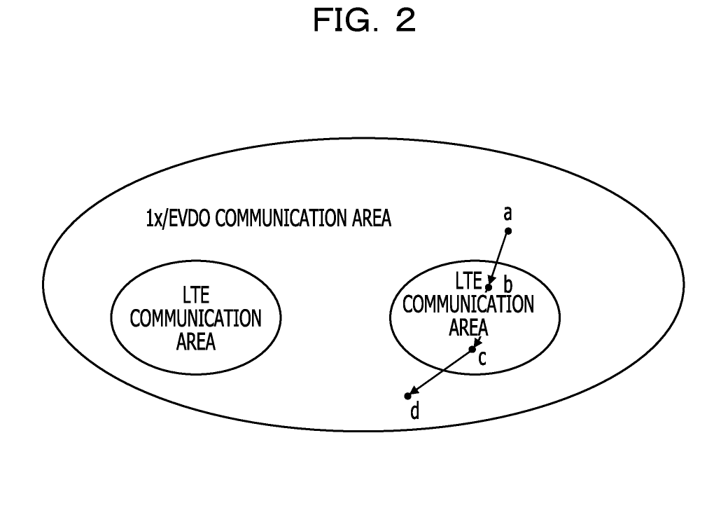

At this time, the service areas of the wireless communications based on the 1× system and the EVDO system which will be hereinafter referred to as “1×/EVDO communication area” and the service area for the wireless communication based on the LTE system which will be hereinafter referred to as “LTE communication area” have a relationship illustrated, for example, in FIG. 2.

FIG. 2 illustrates an example of a relationship between a 1×/EVDO communication area and LTE communication areas.

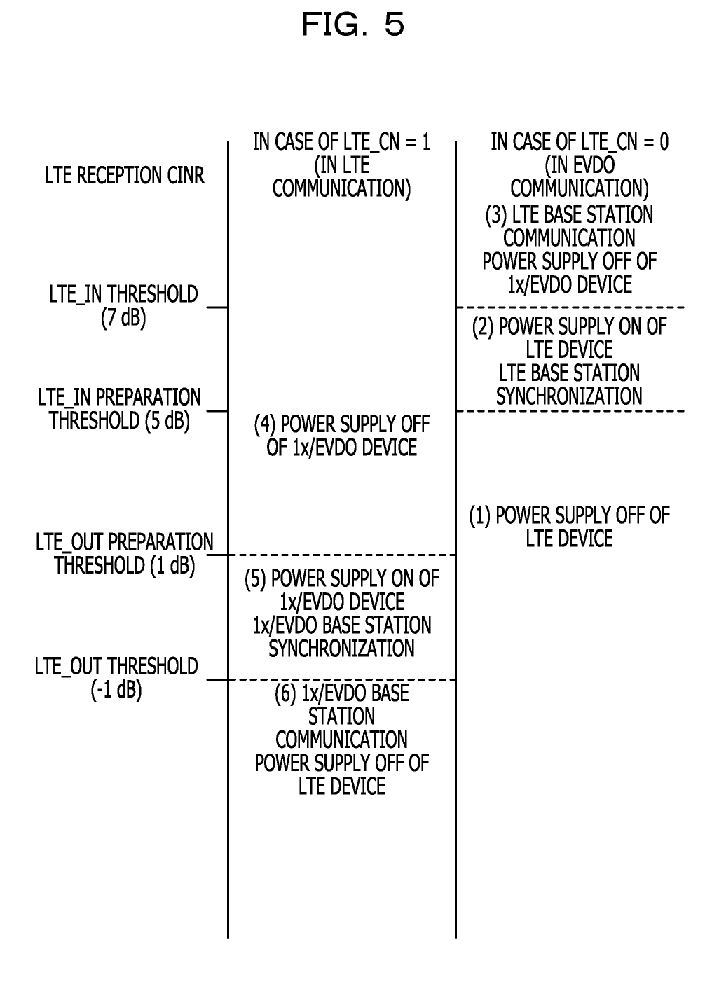

In the example of FIG. 2, the LTE communication area is narrower than the 1×/EVDO communication area. The LTE communication area is also included in the 1×/EVDO communication area. To simplify the description, the following description will be given on the premise of the relationship between the 1×/EVDO communication area and the LTE communication area exemplified in FIG. 2, but the description is not intended to limit the configuration to the relationship between the relationship between the 1×/EVDO communication area and the LTE communication area exemplified in FIG. 2. Locations a, b, c, and d illustrated in FIG. 2 will be used in the description on FIG. 5 below.

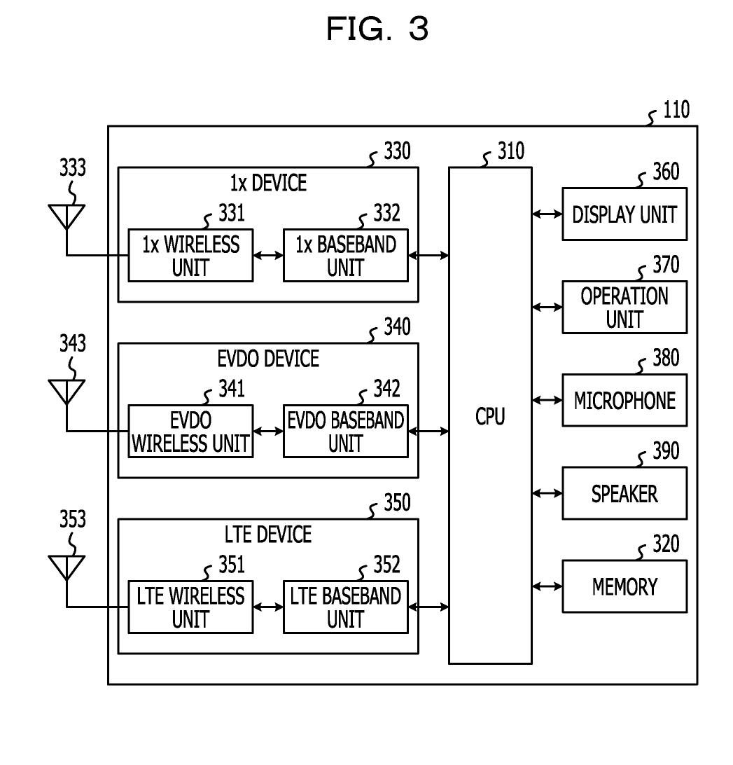

FIG. 3 illustrates a configuration example of the wireless terminal apparatus 110.

The wireless terminal apparatus 110 includes a central processing unit (CPU) 310, a memory 320, a 1× device 330, an EVDO device 340, an LTE device 350, a display unit 360, an operation unit 370, a microphone 380, and a speaker 390. These apparatuses have a configuration of being communicated to each other by a bus to mutually exchange data.

The CPU 310 is an arithmetical unit configured to not only execute peripheral devices and various pieces of software but also execute a program for realizing the wireless communication according to the present embodiment. For example, the CPU 310 executes processing described below in FIG. 8 and FIG. 9 or the like by a predetermined program.

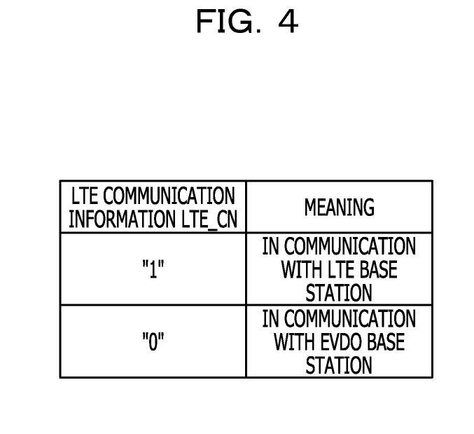

The CPU 310 stores LTE communication information LTE_CN indicating whether or not the wireless communication with the LTE network 140 is established in a predetermined area of the memory 320. As illustrated in FIG. 4, the CPU 310 stores LTE_CN=1 in the memory 320 in the case of the wireless communication with the LTE base station 145 and stores LTE_CN=0 in the memory 320 in the case of the wireless communication with the EVDO base station 134.

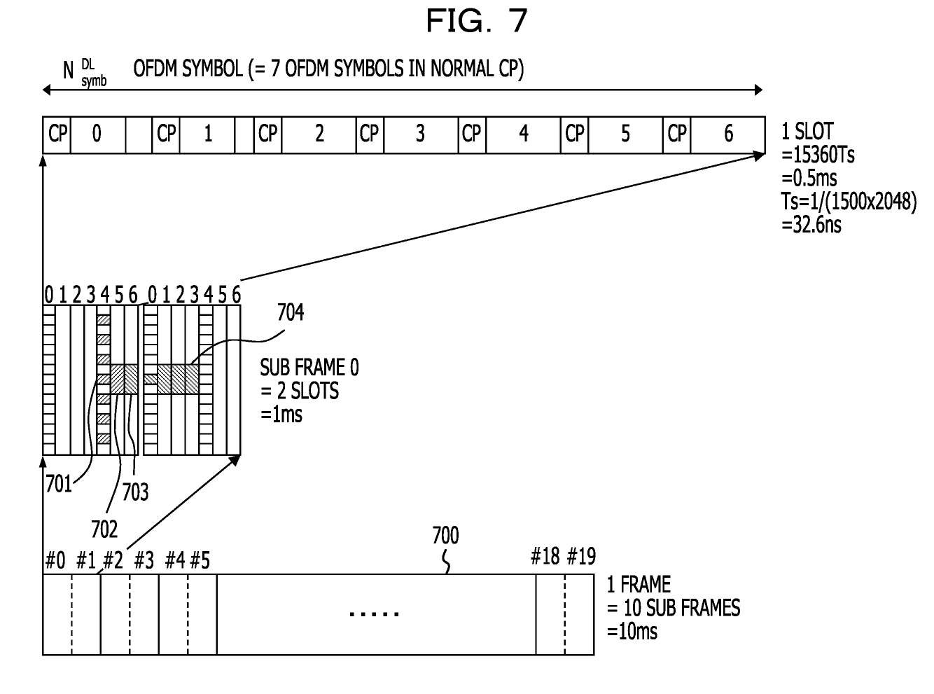

The CPU 310 measures reference signals 701 of base stations located at a sub frame 0 and a sub frame 4 in an LTR downlink frame 700 illustrated in FIG. 7 and calculates a carrier to interference and noise ratio (CINR). In FIG. 7, for example, the reference signals 701 of the base station located at the sub frame 0 included in the LTE downlink frame of 10 ms are exemplified. The LTR downlink frame 700 illustrated in FIG. 7 is a general frame compliant with the LTE system, and therefore a specific description thereof will be omitted.

The CPU 310 further calculates a LTE reception CINR obtained by applying smoothing filter processing using the following expression to the calculated CINR.

LTE reception CINR=(1−a)×(previous CINR)+a×(CINR) (1)

Where (previous CINR) denotes the CINR calculated in the previous time. In contrast, (CINR) denotes the CINR calculated in this time. In addition, “a” denotes a real number that satisfies 0<a≦1. For example, a value of 0.3 or the like can be used as a.

The memory 320 is a volatile storage apparatus used for executing the program. For example, a random access memory (RAM) or the like can be used for the memory 320.

The 1× device 330 includes a 1× wireless unit 331 and a 1× baseband unit 332. The 1× wireless unit 331 generates a baseband signal by demodulating the wireless signal received by an antenna 333 to be output to the 1× baseband unit 332 and generates an RF signal by modulating the baseband signal output by the 1× baseband unit 332 to be transmitted from the antenna 333. The 1× baseband unit 332 decodes the baseband signal output by the 1× wireless unit 331 while following the 1× system and encodes the digital signal sent from the CPU 310 while following the 1× system to be output to the 1× wireless unit 331.

The EVDO device 340 includes an EVDO wireless unit 341 and an EVDO baseband unit 342. The EVDO wireless unit 341 generates a baseband signal by demodulating the wireless signal received by an antenna 343 to be output to the EVDO baseband unit 342 and generates an RF signal by modulating the baseband signal output by the EVDO baseband unit 342 to be transmitted from the antenna 343. The EVDO baseband unit 342 decodes the baseband signal output by the EVDO wireless unit 341 while following the EVDO system and encodes the digital signal sent from the CPU 310 while following the EVDO system to be output to the EVDO wireless unit 341.

The LTE device 350 includes an LTE wireless unit 351 and an LTE baseband unit 352. The LTE wireless unit 351 generates a baseband signal by demodulating the wireless signal received by an antenna 353 to be output to the LTE baseband unit 352 and generates an RF signal by modulating the baseband signal output by the LTE baseband unit 352 to be transmitted from the antenna 353. The LTE baseband unit 352 decodes the baseband signal output by the LTE wireless unit 351 while following the LTE system and encodes the digital signal sent from the CPU 310 while following the LTE system to be output to the LTE wireless unit 351.

The display unit 360 is an apparatus configured to output data or the like to a display apparatus or the like. The display unit 360 may also include the display apparatus. The operation unit 370 is an input unit for data from an external part. A key board, a liquid crystal touch panel, or the like can be used for the operation unit 370, for example. The microphone 380 is an apparatus configured to generate audio data from input audio. The speaker 390 is an apparatus configured to reproduce the received audio data or the like.

A non-transitory medium can be used for a storage medium such as the memory 320 that can be read by the wireless terminal apparatus 110.

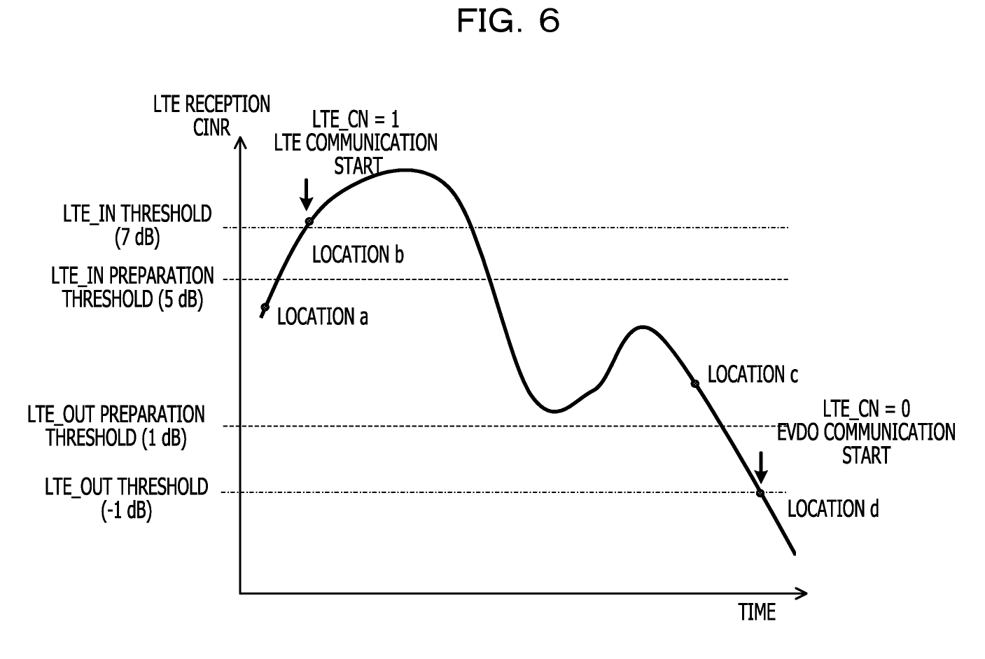

FIG. 5 is an explanatory diagram for describing an outline of a switching processing for the devices (the 1× device 330, the EVDO device 340, and the LTE device 350) by the wireless terminal apparatus 110. Hereinafter, while a case in which the wireless terminal apparatus 110 is moved from the location a to the location d illustrated in FIG. 2 is set as an example, device switching processing by the wireless terminal apparatus 110 will be described. The LTE reception CINR in a case where the wireless terminal apparatus 110 is moved from the location a to the location d illustrated in FIG. 2 changes as illustrated in FIG. 6.

(1) to (6) described below respectively correspond to (1) to (6) described in FIG. 5.

In general, since the service areas of the wireless communications based on the 1× system and the EVDO system are overlapped with each other, the wireless terminal apparatus 110 according to the present embodiment switches on and off the power supplies of the 1× device 330 and the EVDO device 340 at the same time.

First, a case will be considered in which the wireless terminal apparatus 110 is moved from the location a to the location b illustrated in FIG. 2. It is assumed that the LTE reception CINR is higher than or equal to an LTE_IN preparation threshold at the location a, and the LTE reception CINR is higher than or equal to an LTE_IN threshold at the location b.

The LTE_IN preparation threshold is a threshold serving as a reference for conducting a preparation to switch the communication destination of the wireless terminal apparatus 110 from the 1× network 120 and the EVDO network 130 to the LTE network 140. According to the present embodiment, 5 dB is used as the LTE_IN preparation threshold but is not intended to limit the LTE_IN preparation threshold to this value. In addition, the LTE_IN threshold is a threshold serving as a reference to switch the communication destination of the wireless terminal apparatus 110 from the 1× network 120 and the EVDO network 130 to the LTE network 140. According to the present embodiment, 7 dB is used as the LTE_IN threshold but is not intended to limit the LTE_IN threshold to this value.

(1) At this time, the wireless terminal apparatus 110 located at the location a is wirelessly communicated to the 1× base station 126 and the EVDO base station 134. In this case, the wireless terminal apparatus 110 does not communicate with the LTE base station 145, the LTE communication information LTE_CN is set as 0, and the power supply of the LTE device 350 is set as off.

(2) When the LTE reception CINR exceeds the LTE_IN preparation threshold (5 dB) while the wireless terminal apparatus 110 is moved from the location a to the location b, the wireless terminal apparatus 110 switches the power supply of the LTE device 350 from off to on. The wireless terminal apparatus 110 then performs the synchronization processing with the LTE base station 145. Since this synchronization processing can be conducted while following the LTE system, a specific description thereof will be omitted, but the following processing is conducted.

For example, in the synchronization processing with the LTE base station 145, the wireless terminal apparatus 110 establishes the frame synchronization by an extracted primary synchronization signal 702 and an extracted secondary synchronization signal 703 obtained from the LTR downlink frame 700 illustrated in FIG. 7 and extracts a cell ID included in the LTR downlink frame 700. The wireless terminal apparatus 110 then demodulates a physical broadcast channel (PBCH) signal 704 included in the LTR downlink frame 700 by using the extracted cell ID and obtains system information (notification information).

(3) When the wireless terminal apparatus 110 is further moved to the location b and the LTE reception CINR exceeds the LTE_IN threshold (7 dB), the wireless terminal apparatus 110 switches the communication destination from the 1× base station 126 and the EVDO base station 134 to the LTE base station 145. The wireless terminal apparatus 110 also switches the power supplies of the 1× device 330 and the EVDO device 340 from on to off.

(4) The wireless terminal apparatus 110 then sets the LTE communication information LTE_CN as 1.

Next, a case will be considered in which the wireless terminal apparatus 110 is moved from the location c to the location d illustrated in FIG. 2. It is assumed that the LTE reception CINR is lower than an LTE_OUT preparation threshold at the location c, and the LTE reception CINR is lower than an LTE_OUT threshold at the location d.

The LTE_OUT preparation threshold is a threshold serving as a reference for conducting a preparation to switch the communication destination of the wireless terminal apparatus 110 from the LTE network 140 to the 1× network 120 and the EVDO network 130. According to the present embodiment, 1 dB is used as the LTE_OUT preparation threshold but is not intended to limit the LTE_OUT preparation threshold to this value. In addition, the LTE_OUT threshold is a threshold serving as a reference for switching the communication destination of the wireless terminal apparatus 110 from the LTE network 140 to the 1× network 120 and the EVDO network 130. According to the present embodiment, −1 dB is used as the LTE_OUT threshold but is not intended to limit the LTE_OUT threshold to this value.

(5) When the LTE reception CINR is lower than the LTE_OUT preparation threshold (1 dB) while the wireless terminal apparatus 110 is moved from the location c to the location d, the wireless terminal apparatus 110 switches the power supplies of the 1× device 330 and the EVDO device 340 from off to on. The wireless terminal apparatus 110 then performs the synchronization processing with the 1× base station 126 and the EVDO base station 134. Since this synchronization processing can be conducted while respectively following the 1× system and the EVDO system, a specific description thereof will be omitted, but the following processing is conducted.

For example, in the synchronization processing with the 1× base station 126, the wireless terminal apparatus 110 detects a pilot signal transmitted from the 1× base station 126 to identify a base station PN offset and establishes the frame synchronization while the identified base station PN offset is set as a starting point of a base station PN code. When the frame synchronization is completed, the wireless terminal apparatus 110 sets a predetermined orthogonal code (Walsh code 32) and decodes a Sync Channel signal included in the frame transmitted from the 1× base station 126 to obtain the system information (notification information). With regard to the synchronization processing with the EVDO base station 134 too, the wireless terminal apparatus 110 performs the synchronization processing through a similar method.

(6) When the LTE reception CINR is lower than the LTE_OUT threshold (−1 dB) while the wireless terminal apparatus 110 is further moved to the location d, the wireless terminal apparatus 110 switches the communication destination from the LTE base station 145 to the 1× base station 126 and the EVDO base station 134. The wireless terminal apparatus 110 also switches the power supply of the LTE device 350 from on to off. (1) The wireless terminal apparatus 110 then sets the LTE communication information LTE_CN as 0.

As described above, a hysteresis of 8 (7−(−1)) dB is provided between the LTE_IN threshold and the LTE_OUT threshold used according to the present embodiment. It is noted that the hysteresis between the LTE_IN threshold and the LTE_OUT threshold is not intended to be limited at 8 dB, a hysteresis that is considered as appropriate may be provided between the LTE_IN threshold and the LTE_OUT threshold as the occasion arises. It suffices if a relationship “the LTE_IN threshold>the LTE_OUT threshold” is established between the LTE_IN threshold and the LTE_OUT threshold. In addition, the LTE_IN preparation threshold may be lower than the LTE_IN threshold, and the LTE_OUT preparation threshold may be higher than the LTE_OUT threshold.

FIG. 8 and FIG. 9 are flow charts illustrating a specific example of the device switching processing by the wireless terminal apparatus 110.

The wireless terminal apparatus 110 calculates the LTE reception CINR on the basis of the reference signals 701 of the base stations at the sub frame 0 and the sub frame 4 in the LTR downlink frame 700 received from the LTE base station 145 (step S801).

The wireless terminal apparatus 110 refers to the LTE communication information LTE_CN stored in a predetermined address of the memory 320 (step S802). In a case where the LTE communication information LTE_CN is set as 1 (step S802: YES), the wireless terminal apparatus 110 compares the LTE reception CINR calculated in step S801 with the previously determined LTE_OUT preparation threshold (step S802).

In a case where the LTE reception CINR is higher than or equal to the LTE_OUT preparation threshold (step S803: YES), the wireless terminal apparatus 110 switches the power supplies of the 1× device 330 and the EVDO device 340 from on to off (step S804). The wireless terminal apparatus 110 then shifts the processing to step S805. Also in a case where the LTE reception CINR is lower than the LTE_OUT preparation threshold (step S803: NO), the wireless terminal apparatus 110 shifts the processing to step S805.

The wireless terminal apparatus 110 also compares the LTE reception CINR calculated in step S801 with the previously determined LTE_OUT preparation threshold, and the LTE_OUT threshold (step S805). In a case where the LTE reception CINR is higher than or equal to the LTE_OUT threshold and also is lower than the LTE_OUT preparation threshold (step S805: YES), the wireless terminal apparatus 110 shifts the processing to step S806. In this case, the wireless terminal apparatus 110 switches the power supplies of the 1× device 330 and the EVDO device 340 from off to on and performs the synchronization processing with the 1× base station 126 and the EVDO base station 134 (step S806). The wireless terminal apparatus 110 then shifts the processing to step S807. Also in a case where the LTE reception CINR is lower than the LTE_OUT threshold or is higher than or equal to the LTE_OUT preparation threshold (step S805: NO), the wireless terminal apparatus 110 shifts the processing to step S807.

In step S807, the wireless terminal apparatus 110 compares the LTE reception CINR calculated in step S801 with the previously determined LTE_OUT threshold (step S807). In a case where the LTE reception CINR is lower than the LTE_OUT threshold (step S807: YES), the wireless terminal apparatus 110 is wirelessly communicated to the 1× base station 126 and the EVDO base station 134 and sets the LTE communication information LTE_CN as 0 (step S808). The wireless terminal apparatus 110 also switches the power supply of the LTE device 350 from on to off (step S808). The wireless terminal apparatus 110 then shifts the processing to step S801. Also in a case where the LTE reception CINR is higher than or equal to the LTE_OUT threshold (step S807: NO), the wireless terminal apparatus 110 shifts the processing to step S801.

On the other hand, in step S802, in a case where the LTE communication information LTE_CN is set as 0 (step S802: NO), the wireless terminal apparatus 110 shifts the processing to step S809. In this case, the wireless terminal apparatus 110 compares the LTE reception CINR with the previously determined LTE_IN preparation threshold (step S809).

In a case where the LTE reception CINR is lower than the LTE_IN preparation threshold (step S809: YES), the wireless terminal apparatus 110 switches the power supply of the LTE device 350 from on to off (step S810). The wireless terminal apparatus 110 then shifts the processing to step S811. Also in a case where the LTE reception CINR is higher than or equal to the LTE_IN preparation threshold (step S809: NO), the wireless terminal apparatus 110 shifts the processing to step S811.

In step S811, the LTE reception CINR is compared with the previously determined LTE_IN threshold and the LTE_IN preparation threshold (step S811). In a case where the LTE reception CINR is lower than the LTE_IN threshold and also is higher than or equal to the LTE_IN preparation threshold (step S811: YES), the wireless terminal apparatus 110 shifts the processing to step S812. In this case, the wireless terminal apparatus 110 switches the power supply of the LTE device 350 from off to on and performs the synchronization processing with the LTE base station 145 (step S812). The wireless terminal apparatus 110 then shifts the processing to step S813. Also in a case where the LTE reception CINR is higher than or equal to the LTE_IN threshold or is lower than the LTE_IN preparation threshold (step S811: NO), the wireless terminal apparatus 110 shifts the processing to step S813.

In a case where the LTE reception CINR is higher than or equal to the LTE_IN threshold (step S813: YES), the wireless terminal apparatus 110 is wirelessly communicated to the LTE base station 145 and sets the LTE communication information LTE_CN as 1 (step S814). The wireless terminal apparatus 110 also switches the power supplies of the 1× device 330 and the EVDO device 340 from on to off (step S814). The wireless terminal apparatus 110 then shifts the processing to step S801. Also in a case where the LTE reception CINR is lower than the LTE_IN threshold (step S813: NO), the wireless terminal apparatus 110 shifts the processing to step S801.

According to the embodiment described above, the case has been exemplified in which the wireless terminal apparatus 110 is a wireless terminal apparatus that can be wirelessly communicated to the 1× network 120, the EVDO network 130 and the LTE network 140. However, the wireless terminal apparatus 110 is not intended to be limited to a wireless system that can establish the wireless communication. For example, it suffices if the wireless terminal apparatus 110 can be wirelessly communicated to the plural wireless systems and one of the plural wireless systems to which the wireless terminal apparatus 110 can be wirelessly communicated has a function of notifying the wireless terminal apparatus 110 of a call from another wireless system.

In the above-mentioned explanation, the 1× network 120 can be exemplified as an example of a voice communication network. The 1× network 120 and the EVDO network 130 can be exemplified as an example of a first communication network including the voice communication network. The LTE network 140 can be exemplified as an example of a second communication network. The 1× device 330 and the EVDO device 340 can be exemplified as an example of a first communicator. The LTE device 350 can be exemplified as an example of a second communicator. The LTE reception CINR can be exemplified as an example of a reception level with regard to a signal received from a base station included in the second communication network. The LTE_OUT preparation threshold can be exemplified as an example of a first threshold. The LTE_OUT threshold can be exemplified as an example of a second threshold. A measurement unit and a processor can be realized while the CPU 310 is caused to execute a predetermined program.

As described above, when the LTE reception CINR is lower than the LTE_OUT preparation threshold (step S805: YES), the wireless terminal apparatus 110 switches the power supplies of the 1× device 330 and the EVDO device 340 from off to on and performs the synchronization processing with the 1× base station 126 and the EVDO base station 134. For that reason, even in a case where the wireless terminal apparatus 110 is moved from the inside of the LTE communication area to the outside of the LTE communication area (the 1×/EVDO communication area), it is possible to smoothly switch the communication destination from the LTE base station 145 to the 1× base station 126 and the EVDO base station 134.

Similarly, when the LTE reception CINR is higher than or equal to the LTE_IN preparation threshold (step S8011: YES), the wireless terminal apparatus 110 switches the power supply of the LTE device 350 from off to on and performs the synchronization processing with the LTE base station 145. For that reason, even in a case where the wireless terminal apparatus 110 is moved from the outside of the LTE communication area (the 1×/EVDO communication area) to the inside of the LTE communication area, it is possible to smoothly switch the communication destination from the 1× base station 126 and the EVDO base station 134 to the LTE base station 145.

Therefore, the wireless terminal apparatus 110 can switch the communication destination without the cut-off of the communication.

Even in a case where the wireless terminal apparatus 110 is moved out from the LTE communication area too, the communication destination is smoothly switched from the LTE base station 145 to the 1× base station 126 and the EVDO base station 134, so that the power supplies of the 1× device 330 and the EVDO device 340 can be set as off in the LTE communication area. This is because the notification of the 1× paging is conducted by the LTE paging. As a result, the wireless terminal apparatus 110 can suppress the power consumption to the low level. The wireless terminal apparatus 110 then can further increase the life of a battery used by the wireless terminal apparatus 110.

Furthermore, according to the present embodiment, −1 dB is used as the LTE_OUT threshold corresponding to the threshold for switching the communication destination to the 1× base station 126 and the EVDO base station 134 when the wireless terminal apparatus 110 is wirelessly communicated to the LTE base station 145. On the other hand, 7 dB is used as the LTE_IN threshold corresponding to the threshold for switching the communication destination to the LTE base station 145 when the wireless terminal apparatus 110 is not wirelessly communicated to the LTE base station 145, for example, when the wireless terminal apparatus 110 is wirelessly communicated to the EVDO base station 134. In this manner, the hysteresis of 8 dB is provided between the LTE_OUT threshold and the LTE_IN threshold. This hysteresis of 8 dB is an example, but by appropriately providing the hysteresis between the LTE_OUT threshold and the LTE_IN threshold, the wireless terminal apparatus 110 can receive the stable wireless service while occurrence of a pumping operation around a border between the LTE communication area and the 1×/EVDO communication area is suppressed. The pumping operation is an operation for the wireless terminal apparatus 110 to frequently switch the communication destination between the 1× base station 126 and the EVDO base station 134 and the LTE base station 145.

For example, in FIG. 6, once the LTE reception CINR is higher than or equal to the LTE_IN threshold at the location b and the LTE communication is started, even if the LTE reception CINR is lower than the LTE_IN threshold thereafter, the wireless terminal apparatus 110 keeps the LTE communication until the LTE reception CINR is lower than the LTE_OUT threshold at the location d. In this manner, once the communication with the LTE base station 145 is started, even if the LTE reception CINR is lower than the LTE_IN threshold, since the wireless terminal apparatus 110 keeps the LTE communication until the LTE reception CINR is lower than the LTE_OUT threshold this is lower than the LTE_IN threshold, so that it is possible to receive the stable LTE wireless service without the occurrence of the pumping operation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless terminal apparatus comprising:
a first communicator configured to be communicated to a first communication network that provides a voice communication;
a second communicator configured to be communicated to a second communication network that provides a data communication and to notify the wireless terminal apparatus that can be communicated to the second communication network of a call request from the first communication network in a switchable manner;
a memory; and
a processor coupled to the memory and configured to:
measure a reception level with regard to a signal received from a base station included in the second communication network, and
while a communication to the second communication network is established in a state where a power supply of the first communicator is set as off and also a power supply of the second communicator is set as on, switch the power supply of the first communicator from off to on when the reception level is lower than a first threshold that is previously determined as a reference for conducting a preparation to switch the communication destination from the second communication network to the first communication network, and switch the communication destination from the second communication network to the first communication network and switch the power supply of the second communicator from on to off when the reception level is lower than a second threshold that is lower than the first threshold and is previously determined as a reference for switching the communication destination from the second communication network to the first communication network.

2. The wireless terminal apparatus according to claim 1,
wherein while a communication to the first communication network is established in a state where the power supply of the first communicator is set as on and also the power supply of the second communicator is set as off, the processor switches the power supply of the second communicator from off to on when the reception level exceeds a third threshold that is previously determined as a reference for conducting a preparation to switch the communication destination from the first communication network to the second communication network, and switches the communication destination from the first communication network to the second communication network and switches the power supply of the first communicator from on to off when the reception level exceeds a fourth threshold that is higher than the third threshold and is previously determined as a reference for switching the communication destination from the first communication network to the second communication network, and
wherein the fourth threshold is higher than the second threshold.

3. The wireless terminal apparatus according to claim 1,
wherein the processor is configured to measure a carrier to interference and noise ratio (CINR), and
wherein the reception level is calculated by a following expression,
“reception level”=a*CINR_{—}1+(1−a)*CINR_{—}2,
where “a” is a real number that is more than 0 and less than or equal to 1, “CINR_1” is a first CINR measured by the processor, and “CINR_2” is a second CINR measured by the processor before the measurement of the first CINR.

4. The wireless terminal apparatus according to claim 1,
wherein the first communication network includes a communication network that uses code division multiple access (CDMA) 2000 1×.

5. The wireless terminal apparatus according to claim 1,
wherein the second communication network is a communication network that uses Long Term Evolution (LTE).

6. A switching method of switching a communication between a first communication network and a second communication network, the switching method comprising:
measuring at a wireless terminal apparatus, a reception level with regard to a signal received from a base station included in the second communication network that provides a data communication and notifies the wireless terminal apparatus that can be communicated to the second communication network of a call request from the first communication network including a voice communication network that provides a voice communication; and
while a communication to the second communication network is established in a state where a power supply of a first communicator communicated to the first communication network is set as off and also a power supply of a second communicator communicated to the second communication network is set as on, switching, by a processor, the power supply of the first communicator from off to on when the reception level is lower than a first threshold that is previously determined as a reference for conducting a preparation to switch the communication destination from the second communication network to the first communication network, and switching, by the processor, the communication destination from the second communication network to the first communication network and switching the power supply of the second communicator from on to off when the reception level is lower than a second threshold that is lower than the first threshold and is previously determined as a reference for switching the communication destination from the second communication network to the first communication network.

7. The switching method according to claim 6,
wherein while a communication to the first communication network is established in a state where the power supply of the first communicator is set as on and also the power supply of the second communicator is set as off, the power supply of the second communicator is switched from off to on when the reception level exceeds a third threshold that is previously determined as a reference for conducting a preparation to switch the communication destination from the first communication network to the second communication network, and the communication destination is switched from the first communication network to the second communication network and the power supply of the first communicator is switched from on to off when the reception level exceeds a fourth threshold that is higher than the third threshold and is previously determined as a reference for switching the communication destination from the first communication network to the second communication network, and
wherein the fourth threshold is higher than the second threshold.

8. A machine readable medium storing a program for causing a wireless terminal apparatus to perform switching processing of switching a communication between a first communication network and a second communication network, the program, when executed by a processor, causing the processor to perform operations comprising:
measuring a reception level with regard to a signal received from a base station included in the second communication network that provides a data communication and notifies the wireless terminal apparatus that can be communicated to the second communication network of a call request from the first communication network including a voice communication network that provides a voice communication, and
while a communication to the second communication network is established in a state where a power supply of a first communicator communicated to the first communication network is set as off and also a power supply of a second communicator communicated to the second communication network is set as on, switching the power supply of the first communicator from off to on when the reception level is lower than a first threshold that is previously determined as a reference for conducting a preparation to switch the communication destination from the second communication network to the first communication network, and switching the communication destination from the second communication network to the first communication network and switching the power supply of the second communicator from on to off when the reception level is lower than a second threshold that is lower than the first threshold and is previously determined as a reference for switching the communication destination from the second communication network to the first communication network.

9. The machine readable medium according to claim 8,
wherein while a communication to the first communication network is established in a state where the power supply of the first communicator is set as on and also the power supply of the second communicator is set as off, the power supply of the second communicator is switched from off to on when the reception level exceeds a third threshold that is previously determined as a reference for conducting a preparation to switch the communication destination from the first communication network to the second communication network, and the communication destination is switched from the first communication network to the second communication network and the power supply of the first communicator is switched from on to off when the reception level exceeds a fourth threshold that is higher than the third threshold and is previously determined as a reference for switching the communication destination from the first communication network to the second communication network, and
wherein the fourth threshold is higher than the second threshold.

10. A wireless terminal apparatus comprising:
a first communicator configured to be communicated to a first communication network that provides a voice communication;
a second communicator configured to be communicated to a second communication network that provides a data communication and to notify the wireless terminal apparatus that can be communicated to the second communication network of a call request from the first communication network in a switchable manner;
a memory; and
a processor coupled to the memory and configured to:
measure a reception level with regard to a signal received from a base station included in the second communication network, and
refer to the reception level and switch the communication destination by controlling on and off of power supplies of the first and second communicators on the basis of a first threshold that is previously determined as a reference for switching the communication destination from the second communication network to the first communication network and a second threshold that is higher than the first threshold and is previously determined as a reference for switching the communication destination from the first communication network to the second communication network.
